(19) United States
(12) Patent Application Publication
(10) Pub. No.: US 2002/0078022 A1
(43) Pub. Date: Jun. 20, 2002

(54) Enhanced method and system for viewing any search result without returning to the result list

(76) Inventor: Scott S. Lawton, Chelmsford, MA (US)

Correspondence Address: FOLEY, HOAG & ELIOT, LLP, PATENT GROUP, ONE POST OFFICE SQUARE, BOSTON, MA, 02109, US

(21) Appl. No.: 09/972,791

(22) Filed: Oct. 5, 2001

Related U.S. Application Data
(60) Provisional application No. 60/238,754, filed on Oct. 6, 2000.
(60) Provisional application No. 60/238,577, filed on Oct. 6, 2000.
(60) Provisional application No. 60/238,791, filed on Oct. 6, 2000.
(60) Provisional application No. 60/238,587, filed on Oct. 6, 2000.
(60) Provisional application No. 60/237,254, filed on Oct. 2, 2000.
(60) Provisional application No. 60/237,250, filed on Oct. 2, 2000.
(60) Provisional application No. 60/237,243, filed on Oct. 2, 2000.
(60) Provisional application No. 60/237,249, filed on Oct. 2, 2000.

(51) Int. Cl. G06F 7/00

(52) U.S. Cl. 707/1

(57) ABSTRACT

An enhanced method and system for viewing any search result without returning to the result list, whereby users can review more data in less time and with less wasted effort. A computer with appropriate software adds a navigation control that provides a distinct navigation element linked to each data object that met the search criteria, while using less display area than the result list.

### REFERENCE TO RELATED APPLICATIONS

This application claims the benefit of and incorporates by reference the following applications:

U.S. Provisional Application Serial No. 60/238,754 filed Oct. 6, 2000; Method and System of Entering Search Criteria Using Multiple Entry Fields per Data Element, U.S. Serial No. 60/238,577 filed Oct. 6, 2000; Method and System for Combining User-Supplied Sort Information with Secondary Sort Information, U.S. Serial No. 60/238,791 filed Oct. 6, 2000; Method and System for Organizing Information into Visually Distinct Groups Based on User Input, U.S. Serial No. 60/238,587 filed Oct. 6, 2000; Enhanced Method and System for Storing and Managing Search Criteria, U.S. Serial No. 60/237,254 filed Oct. 2, 2001; Method and System for Modifying Search Criteria Based on Previous Search Date, U.S. Serial No. 60/237,250 filed Oct. 2, 2001; Enhanced Method and System for Category Selection, U.S. Serial No. 60/237,243 filed Oct. 2, 2001; Method and System for Pre-Filling Search Criteria into a Form, U.S. Serial No. 60/237,249 filed Oct. 2, 2001, and Method and System for Organizing Search Results into a Single Page Showing Two Levels of Detail, U.S. Serial No. 60/337,252 filed Oct. 2, 2001.

### COPYRIGHT NOTICE

The following patent disclosure includes material that is subject to copyright protection. The copyright owner has no objection to the facsimile reproduction of the disclosure by any person as it appears in the records of the U.S. Patent and Trademark Office, but otherwise reserves all rights to the copyright whatsoever.

### FIELD OF THE INVENTION

The invention relates generally to information retrieval from data repositories, and more particularly to a method and system for viewing any search result without returning to the result list, whereby users can review more data in less time and with less frustration and wasted effort.

### BACKGROUND OF THE INVENTION

As a society, we are increasingly becoming both dependent on and overloaded with information, especially data that is stored in computer databases or full-text collections. As the quantity of information stored in these data repositories increases, the complexity of retrieving, organizing and understanding relevant information also increases. To locate relevant information, users search general collections (e.g., AltaVista, Excite, InfoSeek, Lycos, Yahoo, etc.) as well as specialized sources which may be implemented with back-end databases, such as those dedicated to locating employment opportunities (e.g., CareerBuilder, CareerPath, Headhunter.net, HotJobs, Monster.com, etc.). According to recent studies from technology analysts (e.g., the Jupiter Group and Forrester Research), Internet searching is the most common online activity next to sending/receiving e-mail communications.

Data repositories may take on several forms, including relational databases, hierarchical databases, flat-file databases, full-text collections, one or more documents, etc. As used herein, the term “data element” refers to a database field, a delimited portion of a document, meta information associated with a document, or to an entire document. As used herein, the term “data object” refers to a database record, a document, or some other grouping of associated data elements. As used herein, the term “data unit” refers to the value or contents of a data element. As used herein, the term “page” refers to a document or page on the World Wide Wide or other public or private network, e.g. a continuously scrollable body of information which may or may not include so-called “frames,” (i.e. portions that do not scroll automatically when other portions of the page are scrolled).

Most search engines on the Internet, whether general or specialized, involve three steps (others require more):

(1) a search form: a fill-in form or other means of entering or selecting search criteria;

(2) a result list: a summary list containing a subset of data elements from each data object that meets the search criteria and a link to a detail page with additional info; often containing only one or a few lines per data object; often divided across multiple linked Web pages when the number of matching data objects exceeds a predetermined value; and

(3) a detail page: a page showing all or substantially all of the relevant contents of those portions of the data object that are made available to the user; often as one page per data object but may include details from multiple data objects on a single page; may link to additional information that is related to the displayed information but is considered to be outside the scope of the user's present search.

Most Web searches yield more matches than a user has time to review in detail; often numbering in the hundreds, thousands or even higher. Independent of the number of results, the quality of results varies widely depending on the subject matter, the size of the target data repository, the complexity of the search criteria (more complex generally yields fewer results), the experience of the user, the power of the search engine and other factors. To address both of these issues, the first purpose of the result list is to summarize each matching data object, presenting enough information about each so that users can determine whether they want to view the detail page for that data object.

In the typical case, a detail page is presented by itself, without reference to the context of the search. Said differently, two people who enter different search criteria and whose result list includes some different data objects or data objects in a different order, will see the same detail page when they follow the link from their result list. Indeed, maintaining the search context to present the detail page in reference to it requires additional effort on the part of developers or implementers. Because of the lack of context in the typical case, the second purpose of the result list is to serve as a means to navigate from one detail page to another by returning to the result list in between.

However, navigating between detail pages by returning to the result list page in between is not efficient and can quickly become frustrating. Among the various problem with this approach: going to the next detail page requires at least two actions (back to result list page, forward to next detail page); when returning to the result list page, any scrolling that was done, e.g. to put the most recent item of interest at the top of the screen, is generally lost; even on a high-speed, high-bandwidth network connection and/or with local caching, returning to the result list page rarely has the sub-second response time that is optimal for usability.

One solution to this problem that is available, though not widely used, is to place “Previous” and “Next” links on the detail page, providing direct access to the detail page that immediately precedes the current page and to the detail page that immediately follows the detail page; both in the order presented on the result list. The Verity search engine supports this feature, however, it's not even used on the Verity corporate web site. Providing direct access to the two immediately adjacent detail pages is useful but still limiting; other detail pages can only be accessed by either following a chain of “Previous” or “Next” links the appropriate number of times, or returning to the result list and selecting from there.

The above solutions share an additional problem: no information about the result of the search, such as an absolute or relative indication of the number of matching data objects, or the position of the current data object with respect to others, is available while viewing an individual data object.

The FileMaker database management system provides a partial solution: a label showing the total number of matching data objects, and an entry field plus action button for navigating to a specific data object, where the current contents of the entry field indicate the item number of the current data object. The FileMaker client provides a custom navigation control that mimics an old-fashioned “Roladex,” supporting “Previous” and “Next” behavior by clicking on the previous or next card, and supporting rapid access to non-adjacent data objects by dragging on a sliding tab control. However, this custom control does not translate well to the Web since it can't be implemented using standard, unadorned HTML. It also lacks direct, one-click access to any data object, and has no clear visual (vs. merely numerical) indication of how many data objects are in the result set.

Another solution to this problem that is available, though only useful in certain situations, is to place the entire contents of every detail page onto a single page that can be scrolled as needed to view the detail for any data object. This approach is clearly limited to cases where the total amount of information is modest relative to network bandwidth, display screen size, etc. It also can be more difficult for users to browse and understand the information since scrolling is likely to present each new data object in a different relative location on the screen. And, as above, there's no direct way to navigate to a specific data object.

Another solution to this problem that is available, though not widely used, is to preserve the display of the result list while displaying the detail page in a different “frame” of the active window or in a different window. While this approach can be beneficial in certain situations, it requires a significant amount of screen space, provides no indication on the result list which item is currently displayed in detail, and lacks specific controls for viewing the “Previous” and/or “Next” data object.

When the number of matching data objects exceeds a predetermined value, most Web-based search engines divide the result list across multiple Web pages, with each result list page linking to every other result list page. However, no known search engine uses this approach for navigating between detail pages.

In summary, the prior art provides various ways for a user to view any search result without returning to the result list, but every approach has significant drawbacks and/or limitations.

### SUMMARY OF THE INVENTION

In the present invention, a computer with appropriate software provides an enhanced method and system for viewing any search result without returning to the result list.

The present invention overcomes the prior art limitations by including with each data object that met the search criteria a navigation control that provides a distinct navigation element linked to each additional data object that met the search criteria, while using less display area than the result list.

It is an object of the invention to reduce the time and wasted effort associated with finding and reviewing information, by reducing the number of steps required to view any search result and by providing context with every search result.

Other objects and advantages of the invention will, in part, be obvious, and, in part, be shown from the following description.

### BRIEF DESCRIPTION OF THE DRAWINGS

FIG. 1 is a schematic representation depicting the components of one embodiment of the invention;

FIGS. 2a, 2b, 2c, and 2d each depict one illustrative embodiment of the invention's user interface navigation controls;

FIG. 3 is a flow chart depicting the steps for one illustrative method of one illustrative embodiment of the invention;

FIG. 4 is a schematic representation depicting one illustrative embodiment of the invention, wherein the invention is coupled to a network;

FIG. 5 is a schematic representation depicting one illustrative embodiment of the invention, wherein the invention interacts with a single electronic device.

### LIST OF REFERENCE NUMERALS

10 system with components

12 controller

14 instruction port

16 list port

8 data port

20 output port

28 server computer

50 system with network

2A-52C IADs

54A-54C Web browsers

56 network

58 HTTP Web server

64 data repository

68 server computer

90 system with single electronic device

### Description of the Illustrative Embodiments

To provide an overall understanding of the invention, certain illustrative embodiments will now be described. However, it will be understood by one of ordinary skill in the art that the methods and systems described herein may be adapted and modified for other suitable applications and that such other additions and modifications will not depart from the spirit and scope of the inventive concept.

To more clearly and concisely describe the subject matter of the invention, the following definitions are intended to provide guidance as to the meaning of specific terms used in the following written description, examples, and appended claims. As used herein, the term or phrase:

“communications network” and “network” include a LAN, a MAN, a WAN, an Intranet, an Extranet, the Internet, a wireless network (e.g., according to the WAP protocol), and the like;

“Information Location Mechanism” (hereinafter “ILM”) includes software, firmware and/or systems capable of searching a data repository to locate information that meets search criteria, such systems including database management systems, search engines supporting full-text search, search engines supporting fielded search, search engines supporting regular expressions and/or other patterns, and/or iterative search engines;

“Information Sorting Mechanism” (hereinafter “ISM”) includes software, firmware and/or systems capable of ordering data objects according to sort criteria, such systems including database management systems, text processing library routines, etc.;

“Internet Access Device” (hereinafter “IAD”) includes personal computer systems (hereinafter “PCs”), computer workstations, desktop computers, laptop computers, hand-held computers, television set-top boxes, wireless access devices such as mobile telephones, cellular telephones, pagers, beepers, and other various hand-held wireless devices, and all other devices that have at least one processor, UD and VDU, and are capable of accessing the Internet and/or other networks;

“processor” includes all components, devices, Integrated Circuits (hereinafter “ICs”), modules, software, subsystems, and/or systems that provide control and/or perform arithmetic and logical operations and/or extract computer instructions and/or decode computer instructions and/or execute computer instructions, such as a Central Processing Unit (hereinafter “CPU”), a microprocessor, a controller, and the like; including any associated memory or other electronic storage of data and/or instructions;

“User-input Device” (hereinafter “UD”) includes keyboards, keypads, mice, trackballs, trackpads, wheels, joysticks, graphics tablets, voice recognition devices, motion sensing devices and other devices for one or more users to enter text, numbers or other data and/or for pointing, clicking, tapping, selecting, dragging and/or other gestures or actions;

“Visual Display Unit” (hereinafter “VDU”) includes CRT screens, monitors, video display terminals, LCD screens, LED screens, digital paper, and all other devices that are capable of displaying analog or digital data;

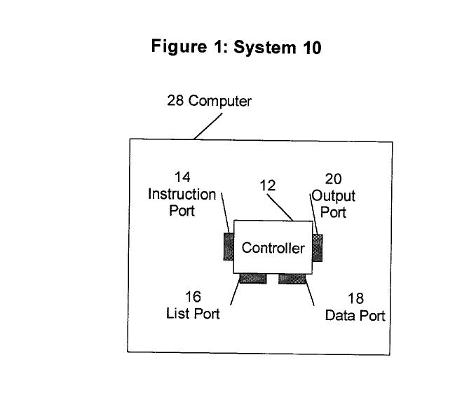

FIG. 1 depicts an illustrative embodiment of one system 10 according to the invention which provides a navigation control for viewing any search result without returning to the result list. The system comprises a controller 12 containing an instruction port 14, a list port 16, a data port 18 and an output port 20.

For this illustrative embodiment, the controller 12 with ports 14, 16, 18 and 20, resides on a single computer 28 which may be a Macintosh G3 running MacOS 8.5. For this illustrative embodiment, the controller 12 is coded in the UserTalk language embedded in UserLand Frontier, a commercial scripting and Web development system.

It will be readily apparent to those skilled in the art that the computer 28 could be a different Macintosh computer running a different version of MacOS or a different OS such as Linux, or an Intel or Intel-compatible PC or server running a version of the Microsoft Windows operating system such as Windows 98, Windows NT or Windows 2000, or an Intel or Intel-compatible PC or server running Linux or FreeBSD or other UNIX OS, or a computer from Sun, HP, IBM or other company, running Solaris, HP-UX, AIX or other variation of UNIX or other OS.

It will be readily apparent to those skilled in the art that the functions performed in this embodiment with a single computer 28 could be divided among a plurality of computers from the same or different manufacturers, with each computer running the same or different operating systems.

It will be readily apparent to those skilled in the art that controller 12 could be coded in any suitable scripting or programming language such as Perl, JavaScript, Java, VBScript, Visual BASIC, C++, etc. or any suitable Web development system such as Vignette StoryServer, Allaire ColdFusion, SilverStream, etc., and that internal portions of controller 12 need not be coded in the same language or system.

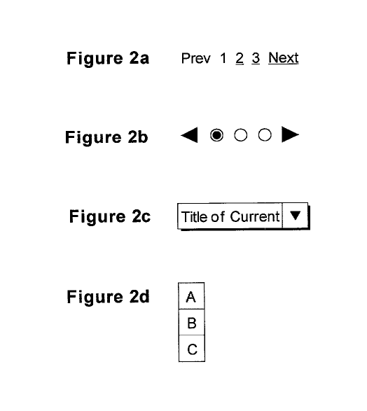

FIG. 2a depicts an example of a navigation control that provides a distinct element for each data object according to this invention. The navigation control consists of one number per data element, here, “1,” “2,” and “3.” This example is intended to be displayed with the contents of data object 1, so the “1” is not a link, and the “2” and “3” are links, indicated by an underline. The navigation control includes two additional elements, “Prev” and “Next.” “Prev” is a placeholder for a link to the previous data object, but since the current data object is the first, there is no previous data object. “Next” is a link to the next data object, in this case the second data object. Because “Next” is a link, it is formatted with an underline. The “Prev” and “Next” elements provide an alternate means of navigation. In this case, the “Next” element leads to the same data object as the “2” element.

FIG. 2b depicts an alternate navigation control for the same case of three data elements with the first being current. The navigation control consists of three radio buttons, with the first selected. The navigation control includes two additional elements, a left arrow to indicate the previous data object (none in this case) and a right arrow indicating the next data object (the second one).

FIG. 2c depicts an alternate navigation control for the same case of three data elements, with the first being current. The navigation control consists of a pop-up or drop-down menu, with the first menu item visible. In this example, the two additional elements are additional menus items that are only visible when the user activates the menu, such as by pressing the mouse button when the cursor is over the menu, or similar action.

FIG. 2d depicts an alternate navigation control for the same case of three data elements with the first being current. The navigation control consists of three square boxes or buttons in a vertical orientation, with the first selected as indicated by the gray background color.

Many variations of these examples will be readily apparent to those skilled in the art, including: mixing and matching various elements; adding or removing “Prev” and “Next” buttons or equivalent; omitting “Prev” or “Next” if there is no associated data object; employing alternate text such as “Previous;” employing a scrollable list instead of a menu; providing a vertical vs. horizontal orientation; omitting the navigation element that would otherwise correspond to the current data object; leaving the navigation element that corresponds to the current data object as a link; and/or using different formatting or no formatting to visually indicate the current data object.

### Operation

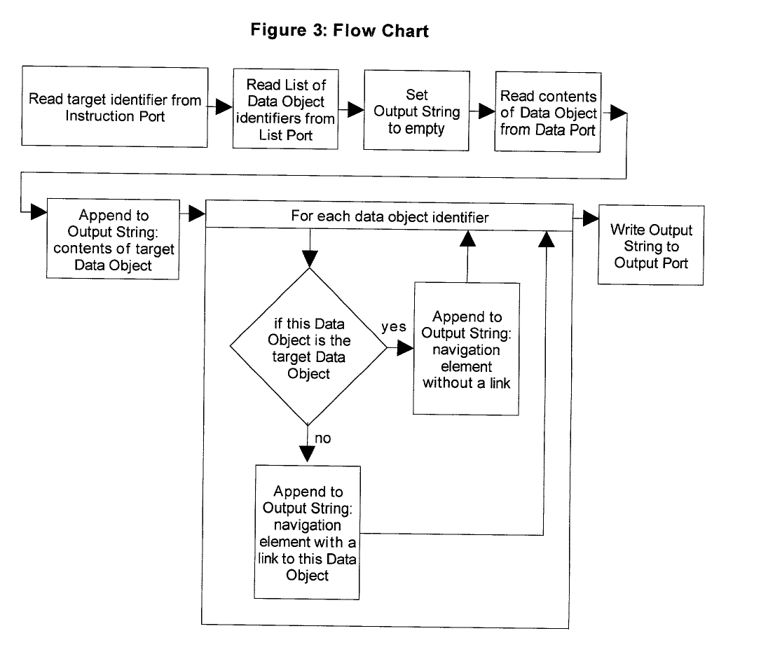

FIG. 3 is a flow chart that depicts the operation of this embodiment wherein the navigation element that corresponds to the current data object is not a link. Controller 12 receives the target identifier from instruction port 14 and a list of data object identifiers from list port 16. Controller 12 sets an Output String to empty then receives the target data object from data port 18 and appends the contents to the Output String. Controller 12 then iterates over each data object identifier. For each identifier, controller 20 determines if the current identifier matches the target identifer; if so, controller 12 appends a navigation element that is not a link to the Output String; if not, controller 12 appends a navigation element that links to the current data object to the Output String. After iterating over each data object, controller 12 then sends the Output String to the output port 20.

It will be readily apparent to those skilled in the art that controller 12 could perform the same or similar functions using somewhat different steps or varying the order of certain steps, and could accept and process information from the instruction port 14 and data port 18 in a variety of formats, each of which may differ from the other. It will be further apparent that controller 12 could omit certain steps depending on the desired output, e.g. by not appending any navigation element for the target data object or not comparing against the target data object if the form of the navigation element does not indicate whether or not it represents the current data object.

### Alternative Embodiments

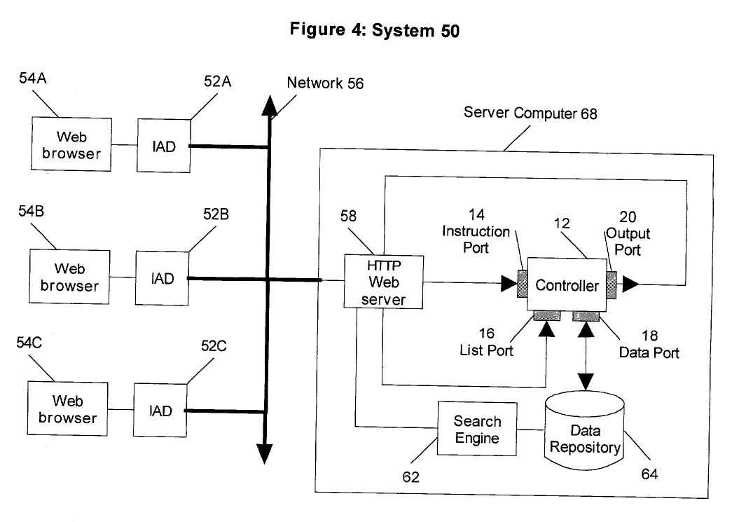

FIG. 4 depicts another illustrative embodiment of one system 50 according to the invention which receives instructions supplied by a user over a network. The system comprises a plurality of IADs 52A-52C, each integrated with or coupled to a Web browser 54A-54C and coupled to a network 56, which is in turn coupled to an HTTP Web server 58, which is coupled to controller 12 via instruction port 14 and list port 16 according to the current invention. Controller 12 is coupled to data repository 64 via data port 18. The controller 12 is coupled via output port 20 to the HTTP Web server 58 in order to return the navigation control and data object to the IADs 52A-52C to display for the users on client processes such as Web browsers 54A-54C.

For this illustrative embodiment, the HTTP Web server 58, search engine 62, data repository 64, and controller 12 with ports 14, 16, 18 and 20 reside on a single server computer 68.

It will be readily apparent to those skilled in the art that the functions performed in this embodiment with a single server computer 68 could be divided among a plurality of server computers from the same or different manufacturers, with each computer running the same or different operating systems.

It will be readily apparent to those skilled in the art that the HTTP Web server 58 could be WebStar, WebTen, Microsoft IIS, Apache or other commercial or open source Web server or Web development system, such as UserLand Frontier, which includes a built-in Web server. It will be readily apparent to those skilled in the art that controller 12 and other components could be coded in any suitable scripting or programming language such as Perl, JavaScript, Java, VBScript, Visual BASIC, C++, etc. or any suitable content management system or application server such as Vignette StoryServer, Allaire ColdFusion, SilverStream, etc. and interact with HTTP Web server 58 via CGI, plug-in, servlets, Enterprise Java Beans, etc., and that the various components need not be coded in the same language or developed in the same content management system or application server.

It will be readily apparent to those skilled in the art that search engine 62 and data repository 64 could be any suitable database management system such as Oracle, Informix, Sybase, SQL Server, Access, mySQL, PostgreSQL, etc. or full-text search engine and associated collection or other index mechanism such as those provided by Verity, UltraSeek, Thunderstone, etc., and/or other software capable of storing and searching data. It will be further apparent that search engine 62 and data repository 64 need not be implemented using the same software nor even reside on the same computer.

### Operation

After performing a search using search engine 62, the user is presented with a result list of items that link to the controller 12. The user controls one or more UDs to select one item via a Web browser 54 running on an IAD 52. The Web browser 54 sends the target data object identifier and a hidden list of data object identifiers over the network 56 via the HTTP protocol to the HTTP Web server 58 running on the server computer 68, which forwards the selected item as a target identifier to controller 12 via instruction port 14, and the hidden list via list port 16. Controller 12 receives data via data port 18, assembles and adds the navigation control, then sends the output via output port 20 to the HTTP Web server 58, which returns the HTML page over the network 56 via the HTTP protocol back to the user's Web browser 54 which displays it on the VDU of IAD 52.

As an alternative, System 50 could be configured such that the hidden list of data object identifiers is replaced with a single hidden set identifier, and the controller 12 reads the set identifier from instruction port 14 then reads a stored list of data object identifiers from storage coupled to list port 16.

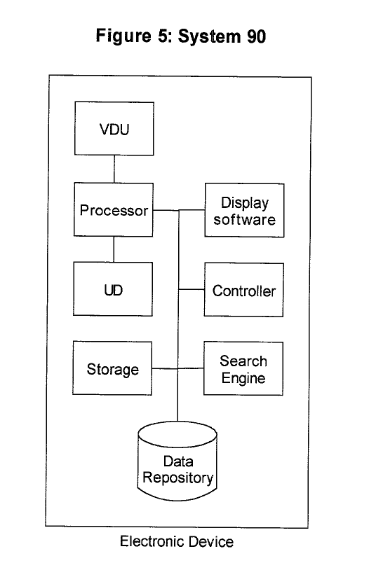

FIG. 5 depicts an illustrative embodiment of one system 90 according to the invention. The system comprises a single electronic device with at least one processor, at least one UD, at least one VDU and some form of storage, with the system 90 running software configured as one or more components to display options, accept user input, perform a search on a local or embedded data repository, display a result list, receive a user selection, a list and data through controller 12, and display the data object contents with a navigation control on the VDU.

It will be readily apparent to those skilled in the art that one or more of the depicted individual components could be moved to a different device, situated locally or remotely, to, for example, support a remote data repository or have certain functions performed remotely.

As previously indicated, those skilled in the art will know or be able to ascertain using no more than routine experimentation, many equivalents to the illustrative embodiments and practices described herein. It will also be understood that the methods and systems described herein provide advantages over the prior art by providing a navigation element for each data object, reducing the time and effort spent finding and understanding information. Accordingly, the scope of the invention should be determined not by the embodiments disclosed herein, but by the following claims, which are to be interpreted as broadly as allowed under the law.

Furthermore, it is to be understood that the terminology used herein is for the purpose of describing particular illustrative embodiments only and is not intended to be limiting. It must be noted that as used herein, including the appended claims, the singular forms “a,” “an,” and “the” include plural referents unless the context clearly dictates otherwise.

What is claimed is:

1. A Streamlined Data Viewing System (SDVS) that provides direct access to every data object while viewing any data object on a Visual Display Unit (VDU) via a client process, each data object resulting from searching an Information Location Mechanism (ILM), each data object having a plurality of data elements, each data element having some or no contents, the SDVS comprising:
an instruction port configured to receive a target identifier indicating the target data object;
a list port configured to receive a list of data object identifiers;
a data port configured to receive the target data object;
an output port configured to send the data object and a navigation control to the client process and/or to the mechanism that invoked the SDVS; and
a controller configured to:
receive the target identifier from the instruction port,
receive the list from the list port,
receive the target data object from the data port,
create a navigation control with one navigation element for each data object in the list, with the exception of the target data object, wherein the navigation control uses less display area than the display area occupied by the aggregate of the title of every data object in the list, and
send the data object and the navigation control to the output port; thereby saving a user time by enabling the user to access any data object that met their search criteria without returning each time to the result list that is typically displayed as the result of a search.

2. The SDVS recited in claim 1 wherein the instruction port, list port, data port, and/or output port is/are coupled to an HTTP Web server, or coupled to a computer-readable media, or configured to communicate via a standard electronic messaging protocol.

3. The SDVS recited in claim 1 wherein the data port is coupled to a document, a database, a database management system, a search engine supporting full-text search, a search engine supporting fielded search, a search engine supporting regular expressions and/or other patterns, and/or an iterative search engine.

4. The SDVS recited in claim 1 wherein each data object is comprised of a database record, a document, or some other grouping of associated data elements.

5. The SDVS recited in claim 1 wherein each data element is comprised of a database field, tagged data including HTML, XML, or SGML, meta data, and/or a document.

6. The SDVS recited in claim 1 wherein each data element is part of a data object, the data object having at least one data unit of employment information.

7. The SDVS recited in claim 1 wherein the controller is configured to create a navigation element for the target data object.

8. The SDVS recited in claim 7 wherein the navigation element for the target data object has a different appearance than the navigation elements for other data objects.

9. The SDVS recited in claim 8 wherein the appearance is made visually distinct by changing the geometry, layout, text font or typeface, text size, text style, text color and/or background color of part or all of the navigation element for the target data object.

10. The SDVS recited in claim 7 wherein the navigation element for the target data object is not a hypertext link.

11. The SDVS recited in claim 1 wherein the controller is configured to add an additional navigation element linked to the data object prior to the target data object, if any.

12. The SDVS recited in claim 11 wherein the additional navigation element is a left-facing or up-facing arrow, rendered textually with at least one “<” character or rendered graphically.

13. The SDVS recited in claim 11 wherein the additional navigation element for the target data object comprises a text label such as “PREV” or “PREVIOUS,” or similar word or phrase in English or other language.

14. The SDVS recited in claim 1 wherein the controller is configured to add an additional navigation element linked to the data object following the target data object, if any.

15. The SDVS recited in claim 14 wherein the additional navigation element is a right-facing or down-facing arrow, rendered textually with at least one “>” character or rendered graphically.

16. The SDVS recited in claim 14 wherein the additional navigation element for the target data object comprises a text label such as “NEXT,” or similar word or phrase in English or other language.

17. The SDVS recited in claim 1 wherein each navigation element is configured such that the client process will display, on the VDU, additional information about the associated data object when a user moves a UD over the navigation element.

18. The SDVS recited in claim 17 wherein the additional information is the title of the target data object.

19. The SDVS recited in claim 1 wherein each navigation element can be activated by a user with a single action using a UD.

20. The SDVS recited in claim 19 wherein the single action is a click or tap.

21. The SDVS recited in claim 1 wherein the single action is press-drag-release.

22. The SDVS recited in claim 1 wherein the navigation elements are arranged horizontally.

23. The SDVS recited in claim 1 wherein the navigation elements are arranged vertically.

24. The SDVS recited in claim 1 wherein the target identifier is a data element identifier.

25. The SDVS recited in claim 1 wherein the target identifier is an index into the list.

26. The SDVS recited in claim 1, further including a list identifier port configured to receive a list identifier, and wherein the list port is coupled to storage, and wherein the controller is configured to get the identified list from storage via the list port.

27. The SDVS recited in claim 26 wherein the list identifier port and the instruction port are the same port, and wherein the controller is configured to extract the target identifier and the list identifier from the instruction port.

28. The SDVS recited in claim 1, further including:
a data cache configured to store a copy of zero or more data objects;
a cache manager configured to:
check if the target data object is already stored in the data cache;
if not, get a copy of the data object via the data port and store it in the data cache;
return a copy of the data object from the data cache to the controller;
and wherein the controller is configured to receive the data objects from the cache manager and/or from the data port.

29. A search system comprising:
a search port configured to receive search criteria;
an Information Location Mechanism (ILM) configured to locate zero or more data objects that match the received search criteria;
a formatting engine configured to format a result list comprising a subset of information from each matching data object;
a client process and VDU configured to display the result list, the data object and the navigation control;
an SDVS as recited in claim 1 wherein the data port is coupled to the ILM and the output port is coupled to the client process which displays on the VDU.

30. The search system recited in claim 29 wherein the controller of the SDVS creates a formatted representation of the navigation control employing a markup language including HTML, XML or SGML.

31. The search system recited in claim 29 wherein the contents of at least one data element of at least one data object include employment information.

32. The search system recited in claim 29, further including:
a sort port configured to receive sort criteria;
an Information Sorting Mechanism (ISM) coupled between the ILM and the formatting engine; the ISM being configured to receive the sort criteria in a predetermined syntax, receive a plurality of data objects from the ILM, sort the data objects according to the sort criteria, and forward the sorted data objects to the VDU.

33. A streamlined data viewing method that provides direct access to every data object while viewing any data object on a Visual Display Unit (VDU) via a client process, each data object resulting from searching an Information Location Mechanism (ILM), each data object having a plurality of data elements, each data element having some or no contents, the method comprising:
receiving a target identifier indicating the target data object;
receiving the list of data object identifiers;
receiving the target data object;
creating a navigation control with one navigation element for each data object in the list of data object identifiers, with the exception of the target data object, wherein the navigation control uses less display area than the display area occupied by the aggregate of the title of every data object in the list; and,
sending the data object and the navigation control to the client process and/or to the mechanism that invoked the method;
thereby saving a user time by enabling the user to access any data object that met their search criteria without returning each time to the result list that is typically displayed as the result of a search.
